(19) United States
(12) Patent Application Publication
(10) Pub. No.: US 2009/0187755 A1
(43) Pub. Date: Jul. 23, 2009

(54) Computer System and Method for Recording Operating Information Thereof

(76) Inventor: CHENG-HSUN LI, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/333,432

(22) Filed: Dec. 12, 2008

(30) Foreign Application Priority Data
Jan. 18, 2008 (TW) 097102043

(51) Int. Cl. G06F 9/00; G06F 12/00

(52) U.S. Cl. 713/2; 711/100; 711/E12.001

(57) ABSTRACT

A computer system and a method for recording operating information are disposed. The computer system includes a storage unit and a first memory unit. The storage unit includes an operating system. The first memory unit includes a BIOS and a detecting program, and it is electrically connected to the storage unit. The computer system is capable of detecting whether an event relating to the BIOS occurs by the detecting program under the operating system, and then operating information of the event is recorded.

### BACKGROUND OF THE INVENTION

1. Field of the Invention

The invention relates to a computer system and, more particularly, to a computer system which is capable of tracing the crux of the problem when the computer has errors and a method for recording operating information thereof.

2. Description of the Related Art

Nowadays, the computer is widely used, which brings great convenience to people, and the computer is an essential auxiliary tool in the work and living of modern people. Therefore, for a person often using the computer, he is beset when the computer has errors suddenly and cannot be used. When a common user faces the condition, he fails to restore the computer and has to turn to a computer maintenance man for help. The maintenance man only can deduce the crux of the problem of the computer from the situation stated by the user to handle the problem. When the user does not well know the basic operating principle of the computer, he often cannot clearly describe the condition, or he may ignore some changes made by him for the computer intentionally or unintentionally. Thus, the maintenance man has to test the computer step by step to find out the reason for the error, which increases the time for maintaining and the manpower cost greatly and dissatisfies the user for the problem cannot be solved quickly.

### BRIEF SUMMARY OF THE INVENTION

One objective of the invention is to provide a computer system and a method for recording operating information thereof. By recording the information of any operation which changes the basic input out system (BIOS) under the operating system (OS), the crux of the problem can be traced according to the record when the computer has errors.

To obtain the above objective, the computer system of the invention includes a storage unit and a first memory unit. The storage unit includes an OS. The first memory unit includes a BIOS and a detecting program, and it is electrically connected to the storage unit. The detecting program detects whether an event relating to the BIOS occurs under the OS and records the operating information of the event. The operating information is recorded in the first memory unit or additionally disposed second memory unit. Thus, the operating information of the event relating to accessing the BIOS under the OS is recorded. When the computer has errors, a user or a maintenance man may refer to the operating information record to find out the crux of the problem.

The method for recording the operating information is applied to a computer system including a first memory unit storing a BIOS. The method includes the steps of: booting the computer system and loading the OS; detecting whether an event relating to the BIOS occurs; and recording the operating information of the event.

The advantage of the invention is that by recording the operating information of the event relating to accessing the BIOS, when the computer system has errors, the crux of the problem may be confirmed via the operating information, which decreases the maintenance time and cost to obtain the objective of quickly restoring the computer system.

### BRIEF DESCRIPTION OF THE DRAWINGS

FIG. 1 is a schematic diagram showing a computer system according to a preferred embodiment of the invention;

FIG. 2 is a main flow chart showing the method for recording operating information according to a preferred embodiment of the invention; and

FIG. 3 is an actual operation flow chart showing the method for recording operating information according to a preferred embodiment of the invention.

### DETAILED DESCRIPTION OF THE EMBODIMENTS

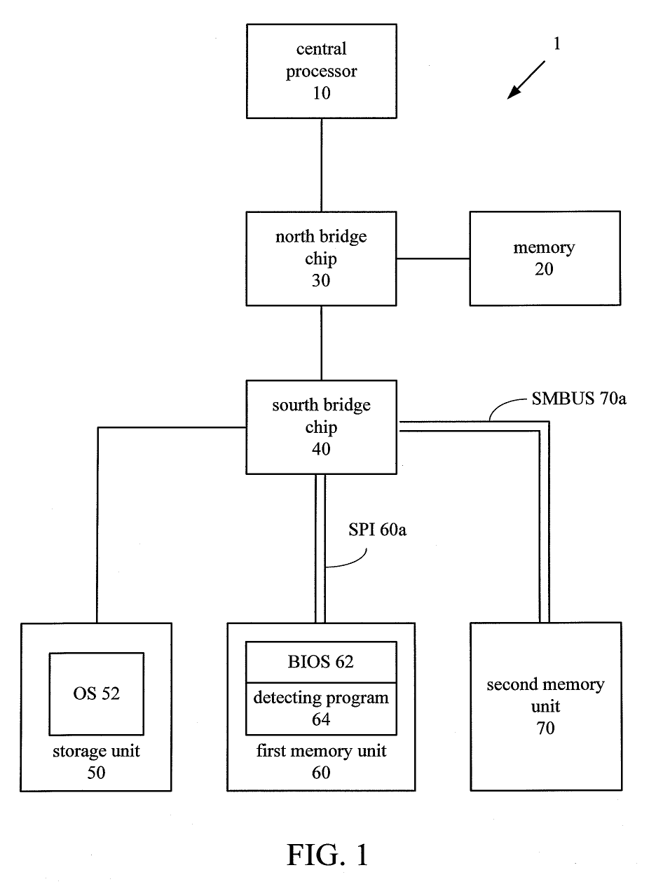

Please refer to FIG. 1. FIG. 1 is a schematic diagram showing the computer system of a preferred embodiment of the invention. As shown in FIG. 1, the computer system 1 includes a central processor 10, a memory 20, a north bridge chip 30, a south bridge chip 40, a storage unit 50 and a first memory unit 60. The north bridge chip 30 is electrically connected to the central processor 10, the memory 20 and the south bridge chip 40, respectively. In one embodiment of the invention, the storage unit 50 is electrically connected to the south bridge chip 40, and it is a hard disk device and stores an OS 52. In one embodiment of the invention, the OS 52 may be a DOS OS, Windows OS or Linux OS, and the invention is not limited thereto. The operating system 52 also may be another kind of the OS.

The first memory unit 60 stores the codes of a BIOS 62 and a detecting program 64. The first memory unit 60 may be electrically connected to the south bridge chip 40 via the serial peripheral interface (SIP) 60a or the low pin count (LPC) to transmit data. In one embodiment of the invention, the first memory unit 60 is a flash memory. However, the invention is not limited thereto. The first memory unit 60 also may be an electrically erasable programmable read-only memory (EEPROM) or another kind of nonvolatile memory, which changes according to the different need or design.

The detecting program 64 is designed to detect any event which wants to access the BIOS 62. When the computer system 1 is booted and finishes the power on self test (POST), it enters an operating environment of the OS 52. Under the operating environment, when any event relating to accessing the BIOS is executed, the detecting program 64 may detect the occurrence of the event and send commands to notify the system to record the operating information of the event. The situation that the computer system 1 has errors and cannot be booted often is caused by improperly changing or destroying the BIOS 62. Via the design of the preferred embodiment of the invention, the events relating to accessing the BIOS 62 and executed by the computer system 1 under the operating system 52 are recorded. Once the computer system 1 has errors and cannot be used, the record data of the operating information is extracted out and is analyzed. Thus, the crux of the problem may be found out quickly, and the cost for maintaining is saved.

In one embodiment of the invention, by predefining the bits of the first memory unit 60, the content of the recorded operating information may be changed. For example, according to the change of the parameters, whether the BIOS is updated and whether the updating is successful may be known. Other definitions capable of determining the changing state of the BIOS 62 may be made, and the invention is not limited thereto. In one embodiment of the invention, the event relating to accessing the BIOS 62 includes enabling the updating program of the BIOS 62 or enabling the program calling the BIOS 62 via the application program under the OS 52, and it also includes other event program accessing the BIOS 62. In addition, in one embodiment of the invention, the operating information may be recorded in a first memory unit 60.

As shown in FIG. 1, the computer system 1 further includes a second memory unit 70 electrically connected to the south bridge chip 40 via the system management bus (SMBus) 70a to transmit data. The operating information of the event relating to accessing the BIOS 62 also may be set to be recorded in the second memory unit 70. When the BIOS 22 and the operating information are both stored in the first memory unit 60, the action of erasing data is repeatedly done in the process of recording the operating information, which risks carelessly erasing the program of the BIOS 62. Thus, to avoid the above mentioned situation, according to the design of a preferred embodiment of the invention, the record of the operating information is stored in the additionally disposed second memory unit 70. Since the second memory unit 70 is independently disposed, the second memory unit 70 may be separated from the motherboard when needed to extract the record of the operating information out to trace and confirm the crux of the problem. By predefining the bits of the second memory unit 70, the content of the recorded operating information may be adjusted. In this embodiment, the second memory unit 70 may be a nonvolatile memory such as a flash memory or an EEPROM, and the invention is not limited thereto.

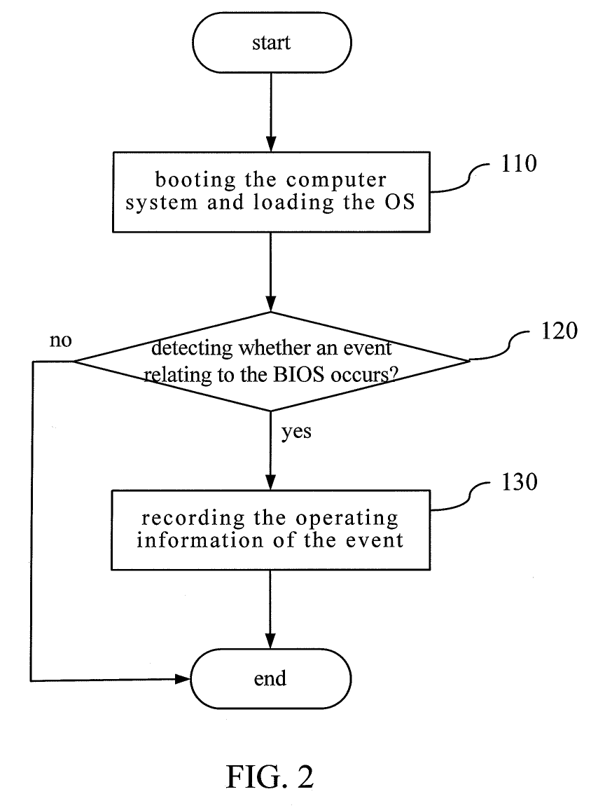

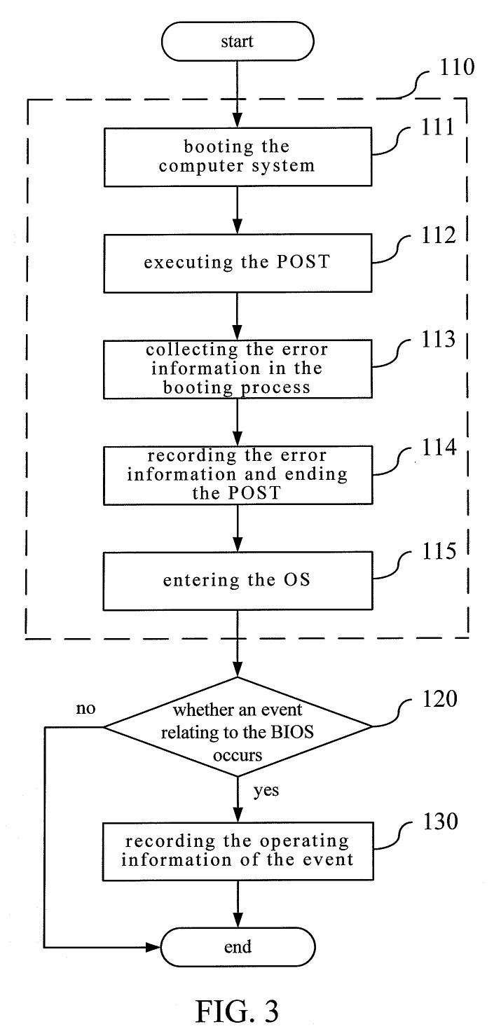

Please refer to FIG. 2 and FIG. 3. FIG. 2 is a main flow chart showing the method for recording operating information according to a preferred embodiment of the invention. FIG. 3 is an actual operation flow chart showing the method for recording the operating information according to the preferred embodiment of the invention. The method for recording the operating information according to the preferred embodiment of the invention is described with the computer system 1 in FIG. 1. The invention is not limited to the computer system 1, and other computer system also may use the method for recording the operating information of the invention. As shown in FIG. 2, the method for recording the operating information of the preferred embodiment includes the steps 110, 120 and 130. The steps of the method for recording the operating information according to the preferred embodiment are described hereinbelow.

First, in step 110, the computer system is booted, and it loads the OS. As shown in FIG. 1 and FIG. 2, the method for recording the operating information of the preferred embodiment of the invention may be adapted to the computer system 1. The computer system 1 includes a first memory unit 60 storing the codes of the BIOS 62. After the power of the computer system 1 is on, the computer system 1 loads the operating system 52 after the POST of the BIOS 62 is finished. As shown in FIG. 3, the step 110 further includes the following steps.

In step 111, the computer system is booted. A user may boot the computer system to operate by switching the power switch of the computer system 1.

In step 112, the POST is executed. After the computer system 1 is powered on in the step 111, the BIOS 62 executes the functional test, parameter initialization and comparison program for the hardware of the computer system 1 to assure that the computer system 1 may be booted normally.

In step 113, the error information in the process of booting the computer is collected. If it is detected that the hardware breaks down or the parameter is not corresponding when the hardware parameters are compared in the process of booting the computer in the step 112, the BIOS 62 may collect the error information one by one.

In step 114, the error information is recorded, and the POST is ended. As shown in FIG. 1, the error information collected in the step 113 may be recorded in the first memory unit 60 or the second memory unit 70, and the POST is ended after the record is finished. The recorded error information may be extracted out to assist in finding out the crux of the problem when the computer system 1 has errors.

In step 115, the OS is loaded. As shown in FIG. 1, the computer system 1 includes a storage unit 50 storing the OS 52. When the POST of the computer system 1 is finished, the BIOS 62 passes the main control right of the computer system 1 to the OS 52. After the OS 52 is loaded, the computer system 1 enters the operating environment of the OS 52.

Afterward, step 120 is performed after the step 110. In the step 120, whether an event relating to the BIOS occurs is detected. As shown in FIG. 1, the first memory unit 60 of the computer system 1 includes the detecting program 64. The event relating to the BIOS 62 under the OS 52 is monitored by the detecting program 64. When the event relates to accessing the BIOS 62, the detecting program 64 may detect the occurrence of the event and make further processing. Generally, when the BIOS is updated, or the BIOS 62 needs to be called to assist in transmitting and processing the commands when some application programs are executed, the detecting program 64 may detect the access state like the portal of the BIOS 62. If no event relating to accessing the BIOS 62 is detected, the OS keeps the normal operating state.

If an event relating to accessing the BIOS 62 is detected in the step 120, step 130 is executed: recording the operating information of the event. As shown in FIG. 1, after the detecting program 64 detects an event relating to accessing the BIOS 62, it may record the operating information of the event. According to the different setting of the computer system 1, the operating information may be stored in the first memory unit 60 having the BIOS 62 or the additionally disposed second memory unit 70.

Via the design of the preferred embodiment of the invention, any event relating to accessing the BIOS 62 and executed under the OS 52 may be completely recorded. When a user makes some program executed or makes the BIOS updated, which causes the computer system 1 to have errors, the maintenance terminal may obtain the record of the operating information from the computer system 1, refer to the record of the operating information and trace to analyze the crux of the problem with the cooperation of the error information record obtained in the process of booting the computer. Thus, the problem of the computer system 1 may be known quickly and may be solved, which saves the time and manpower.

Although the present invention has been explained in relation to its preferred embodiment, it is to be understood that many other possible modifications and variations can be made without departing from the spirit and scope of the invention as hereinafter claimed.

What is claimed is:

1. A method for recording operating information, the method adapted to a computer system including a first memory unit storing a basic input output system (BIOS), the method comprising the steps of:
booting the computer system and loading an operating system (OS);
detecting whether an event relating to the BIOS occurs; and
recording the operating information of the event.

2. The method according to claim 1, wherein the event comprises enabling an updating program of the BIOS.

3. The method according to claim 1, wherein the event comprises enabling a program calling the BIOS via an application program.

4. The method according to claim 1, wherein the operating information is recorded in the first memory unit or a second memory unit.

5. The method according to claim 4, wherein the operating information predefines the bits of the first memory unit or the second memory unit.

6. The method according to claim 4, wherein the second memory unit transmits data via a system management bus (SMBus).

7. The method according to claim 1, wherein the event is detected by a detecting program stored in the first memory unit.

8. A computer system capable of recording user operating information, the computer system comprising:
a storage unit storing an operating system (OS); and
a first memory unit storing codes of a basic input output system (BIOS) and a detecting program;
wherein whether an event relating to the BIOS occurs under the operating environment of the operating system in the computer system is detected by the detecting program, and the operating information of the event is recorded.

9. The computer system according to claim 8, wherein the event comprises enabling an updating program of the BIOS.

10. The computer system according to claim 8, wherein the event comprises enabling a program calling the BIOS via an application program.

11. The computer system according to claim 8, wherein the operating information is recorded in the first memory unit or a second memory unit.

12. The method according to claim 11, wherein the operating information predefines the bits of the first memory unit or the second memory unit.

13. The computer system according to claim 11, wherein the second memory unit transmits data via a system management bus (SMBus).
